(19) United States
(12) Patent Application Publication
(10) Pub. No.: US 2009/0042999 A1
(43) Pub. Date: Feb. 12, 2009

(54) COMPOSITION FOR POLYURETHANE FOAM, POLYURETHANE FOAM MADE FROM THE COMPOSITION, AND METHOD FOR PREPARING POLYURETHANE FOAM

(75) Inventors: Jin Gyu LEE, Seoul (KR); Myung Sup JUNG, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/050,607

(22) Filed: Mar. 18, 2008

(30) Foreign Application Priority Data
Aug. 9, 2007 (KR) 10-2007-0080030

(51) Int. Cl. C08G 18/00; C08J 9/00

(52) U.S. Cl. 521/82; 521/154

(57) ABSTRACT

Example embodiments provide a composition for a polyurethane foam including a silane precursor and/or polysilsesquioxane resin, and a preparation method of the polyurethane foam. A polyurethane foam having improved mechanical properties and insulation characteristic can be obtained by including the silane precursor and/or a polysilsesquioxane in the formation of the polyurethane foam.

### PRIORITY STATEMENT

This non-provisional application claims priority under 35 U.S.C. § 119 Korean Patent Application No. 10-2007-0080030, filed on Aug. 9, 2007 in the Korean Intellectual Property Office (KIPO), the entire contents of which are herein incorporated by reference.

### BACKGROUND

1. Field

Example embodiments relate to a composition for a polyurethane foam, a polyurethane foam made from the composition, and a method for preparing the polyurethane foam. More particularly, example embodiments relate to a composition for a poyurethane foam capable of improving mechanical properties and insulation effects of a polyurethane foam by including a silane precursor and/or polysilsesquioxane, a polyurethane foam made from the composition, and a method for preparing the polyurethane foam.

2. Description of the Related Art

A polyurethane foam refers to a soft or had porous urethane fabricated by mixing a foaming agent, a catalyst, a surfactant, and the like to an isocyanate and a polyol as base materials of urethane, and reacting the mixture. The foaming agent is vaporized by the reaction heat generated during the reaction to form a foam. The polyurethane foam has been used as an insulation material for construction, refrigeration and other industrial uses due to their low thermal conductivity and high insulation effect. As a representative example, a polyurethane foam uses trichlorofluoromethane-11 (CFC-11) as a foaming agent. However, since the use of chlorofluorocarbon (CFC) is recently restricted to protect the ozone layer of the earth, the use of the polyurethane foam composite using the chlorofluorocarbon as a foaming agent is also restricted. Therefore, a demand for a new substitute of the foaming agent is on the rise. As a result, a polyurethane foam using hydrochlorifluorocarbon-141b (HCFC-141b) or cyclopentane as a foaming agent has been mass-produced. Such a polyurethane foam has a thermal conductivity (K-factor) of about 0.020 kcal/mh° C. Thus, in order to achieve the maximum volumetric efficiency, a thermal conductivity of about 0.0100 kcal/mh° C. or lower is necessary. However, it is impossible to realize such thermal conductivity with the present technology.

Vacuum insulating materials other than the polyurethane foam have a thermal conductivity of about 1/7 to 1/10 of that of the polyurethane foam. However, there is a big disadvantage in the cost, and there are performance deterioration and structural problems. Therefore, a demand for a novel insulating material having a high energy efficiency and lightweight is on the rise. As a result, a material such as aerogel has been developed and is currently in examination. However, there are problems in that the price and productivity of the material are not competitive, and the application of the material to the not competitive, and the application of the material to the refrigerator is not easy.

Meanwhile, many attempts have been made to improve the insulation characteristic of a foam using a foaming agent other than chlorofluorocarbon. However, a substance ensuring the insulation characteristic and strength that can surely substitute the chlorofluorocarbon foaming agent has not been developed completely.

### SUMMARY

Therefore, example embodiments have been made in view of the problems of the prior art and provide a composition for polyurethane foam having excellent mechanical properties and insulation effects through including a silane precursor and/or polysilsesquioxane.

Example embodiments also provide a polyurethane foam made from the composition and a method for preparing the polyurethane.

In accordance with example embodiments, a composition for polyurethane foam comprises a premixed polyol and isocyanate, and further comprises at least one among a silane precursor and polysilsesquioxane.

In accordance with example embodiments, a method for preparing a polyurethane foam comprises, adding a catalyst, a surfactant, and a foaming agent to a polyol to prepare a premixed polyol, mixing at least one among a silane precursor and polysilsesquioxane to the premixed polyol, and mixing isocyanate to the mixture to carry out foaming.

In accordance with example embodiments, a polyurethane foam is prepared according to the above preparation method.

According to example embodiments, upon including a silane precursor or polysilsesquioxane in the polyurethane foam formation reaction, a polyurethane foam having improved mechanical properties and insulation effects can be obtained by forming a silicate/polyurethane foam or a polysilsesquioxane/polyurethane foam.

### BRIEF DESCRIPTION OF THE DRAWINGS

Example embodiments will be more clearly understood from the following detailed description taken in conjunction with the accompanying drawings. FIGS. 1-3 represent non-limiting, example embodiments as described herein.

FIG. 1 is a schematic view illustrating a process for forming a polysilsesquioxane/polyurethane foam according to an example embodiment;

FIG. 2 is a surface FESEM image (left) and a sectional FESEM image (right) of a silicate/polyurethane foam according to Example 1 of example embodiments; and

FIG. 3 is a surface FESEM image (left) and a sectional FESEM image (right) of a polyurethane foam according to an embodiment of a conventional art.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. In particular, the relative thicknesses and positioning of molecules, layers, regions and/or structural elements may be reduced or exaggerated for clarity. The use of similar or identical reference numbers in the various drawings are intended to indicate the presence of a similar or identical element or feature.

### DETAILED DESCRIPTION OF EXAMPLE EMBODIMENTS

Example embodiments will now be described in greater detail with reference to the accompanying drawings.

Example embodiments are directed to a composition for polyurethane foam including a premixed polyol and isocyanate, and further including at least one among a silane precursor and polysilsesquioxane.

According to example embodiments, the premixed polyol includes a polyol, an amine catalyst, a surfactant, and a foaming agent.

More specifically, the composition for polyurethane foam includes 100 parts by weight of a polyol, 1 to 99 parts by weight of a silane precursor and/or polysilsesquioxane, 101 to 150 parts by weight of isocyanate, 0.1 to 50 parts by weight of a catalyst, 0.1 to 50 parts by weight of a surfactant, and 1 to 150 parts by weight of a foaming agent. The silane precursor and polysilsesquioxane have a composition ratio of 1:9 to 9:1.

In example embodiments, a usable example of a silane precursor is represented by the following formula 1.

RₘSi(OR)₄₋ₘ [Formula 1]

wherein, R is an alkyl group having 1 to 5 carbon atoms or a phenyl group, and m is an integer of 0 to 3.

Examples of the silane precursor include methyl trimethoxy silane, methyl triethoxy silane, methyl tripropoxy silane, dimethyl dimethoxy silane, dimethyl diethoxy silane, diethoxy(3-glycidyloxypropyl)methyl silane, diethoxymethylphenyl silane, diethoxymethylvinyl silane, diphenyldiethoxy silane, dimethyldichloro silane, dimethylethoxyvinyl silane, ethyltrimethoxy silane, ethyltriethoxy silane, methyltrichloro silane, ethyltrichloro silane, tetraethyl orthosilicate, or the like, but it is not limited thereto.

In the composition for polyurethane foam of example embodiments, it is preferable that an amount of the silane precursor is 3 to 50 parts by weight based on 100 parts by weight of the premixed polyol.

In example embodiments, a usable example of the polysilsesquioxane is represented by the following formula 2.

[R—SiO_{1.5}]ₙ [Formula 2]

wherein, R is at least one selected from the group consisting of alkyl having 1 to 3 carbon atoms, alkenyl having 1 to 3 carbon atoms, cycloalkyl having 3 to 10 carbon atoms, aryl having 6 to 15 carbon atoms, alkaryl having 1 to 3 carbon atoms, hydrogen, or hydroxyl, and n is an integer of 3 to 1000.

In the composition for polyurethane foam of example embodiments, it is preferable that an amount of the polysilsesquioxane is 3 to 50 parts by weight based on 100 parts by weight of the premixed polyol. Moreover, the polysilsesquioxane has a weight-average molecular weight of 500 to 100,000. When the molecular weight is less than 500, a dispersion is not smoothly carried out. When the molecular weight exceeds 100,000, a phase separation is generated so that mixing is not easily carried out. It is also preferable that the polysilsesquioxane includes 5 to 40% of a silanol group. When the silanol group is included less than 5% or exceeding 40%, it is not easy to react with isocyanate. According to example embodiments, the silane precursor and/or polysilsesquioxane is dispersed into the polyurethane foam by including a polyol and isocyanate as in the following reactions 1 and 2.

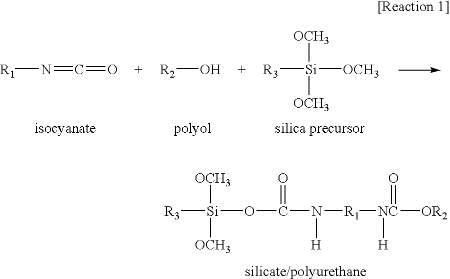

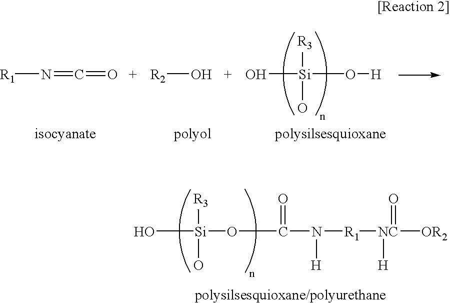

The reaction 1 represents the substitution of a carbon bond with a Si—O bond by including the silica precursor to the reaction of polyol and isocyanate. The reaction 2 represents the substitution of a carbon bond with a Si—O bond by including the polysilsesquioxane to the reaction of polyol and isocyanate. As a result, the insulation characteristic is increased due to a low thermal conductivity of silicone, and the mechanical strength reduction is prevented due to introduction of silicone.

In example embodiments, the premixed polyol includes a polyol, an amine catalyst, a surfactant, a foaming agent, and the like. The reaction content of each component is in the range widely known in this field of art.

The polyol used in example embodiments is an aliphatic compound having two or more hydroxyl groups (—OH) in the molecule. Examples of the polyol that can be used in example embodiments include polypropylene glycol polyols, amine terminated polyether polyols, polytrimethylene ether glycol polyol, polytrimethylene ether ester glycol polyol, polytrimethylene-co-ethylene ether glycol polyol, polytetramethylene ether glycol polyol, polyester polyols such as adipic acid, phthalic anhydride or terephthalic acid, or an arbitrary mixture thereof, but it is not particularly limited thereto.

As the foaming agent used in example embodiments, water is preferably used. Also, a foaming agent other than water can be used together with water. Examples of the other foaming agents include n-pentane, isopentane, cyclopentane, methyl chloride, 1,1,1,2-tetrafluoroethane, 1,1,1,3,3,-pentafluoropropane, 1,1,1,3,3-pentafluorobutane, 1,1-dichloro-1-fluoroethane, 1-chloro-1,1-difluoroethane, chlorodifluoromethane, or the like.

In example embodiments, it is important to select and control a use amount of an appropriate catalyst for improving a foaming characteristic, a reaction time and an air permeability of the foam, and minimizing a density gradient. Examples of the catalyst that can be used in example embodiments include amine catalysts such as triethylamine, diethanol, amine, N,N,N,N′-tetramethylhexane diamine, N,N,N,N′-tetramethylethylene diamine, triethylene diamine, N-methylmorpholine, dimethylamino ethanol, bis(2-dimethylaminoethyl)ether, or 1,8-diazabicyclo(5,4,0)-undecene-7, and organometallic catalysts such as dibutyl laurate, dibutyl tin diacetate, stannous octoate, dibutyl mercaptide, dibutyl tin thiocarboxylate, dibutyl tin malate, dioctyl tin mercaptide, dioctyl tin thiocarboxylate, phenyl mercury, silver propionate, or tin octenaoate. Among these catalysts, an amine catalyst is inevitable, and if necessary, an organometallic catalyst may be added. It is also possible that a plurality of catalysts are used in a combination. Among these, a tertiary amine is particularly preferable. A reactivity of an amine catalyst is influenced by its basicity and steric hindrance.

The surfactant that can be used in example embodiments include nonionic polyether surfactants in addition to silicone surfactants. The silicone surfactants include commercially available polysiloxane/polyether copolymers, for example, Tegostab (B-8462 and B-8404 surfactants, manufactured by Goldschmidt Chemical Corp.), Niax (L-6900 and L-6910 surfactants, manufactured by GE Silicones), or DC-198 and DC-5043 surfactants (manufactured by Dow Corning Corp.). The nonionic polyether surfactant include ethylene oxide/propylene oxide and ethylene oxide/butylene oxide block copolymer. The surfactant gives stability to the foam by reducing a surface tension to improve miscibility, homogenizing the size of bubbles, and controlling the cell structure of the foam.

The composition for polyurethane foam of example embodiments may further include a foam stabilizer, a cell control agent, a filler, a pigment, a dye, a flame retardant, a hydrolysis inhibitor, an antistatic agent, a colorant, an antibiotic, an antifungal agent, or a bacteriostatic agent within a range not to impair the compositional properties.

In example embodiments, the isocyanate in a base material that terms polyurethane by reacting with the polyol. Specific examples of the isocyanate include methylene diphenyl diisocyanate (MDI), polymeric methylene diphenyl diisocyanate, toluene diisocyanate (TDI), hexamethylene diisocyanate, trimethyl hexamethylene diisocyanate, phenylene diisocyanate, dimethyl diphenyl diisocyanate, tetra methylene diisocyanate, iso holon diisocyanate, diisocyanate, triphenyl methane triisocyanate, or an arbitrary mixture thereof, but it is not particularly limited thereto.

It is preferable that an amount of the isocyanate is 101 parts to 150 parts by weight based on 101 parts by weight of polyol.

Example embodiments are also directed to a method for preparing a polyurethane foam. As an example of preparing a polyurethane foam according to the method of example embodiments, first, a catalyst, a surfactant, and a foaming agent are added to a polyol to prepare a premixed polyol, and then a silane precursor and/or polysilsesquioxane is added to the premixed polyol. Subsequently, an isocyanate is added to the mixture of the premixed polyol and the silane precursor and/or polysilsesquioxane, and the resulting mixture is foamed. The components used in the preparation method of example embodiments are the same as described above.

More specifically, in order to prepare the polyurethane foam according to example embodiments, first, 0.1 to 50 parts by weight of a catalyst, 0.1 to 50 parts by weight of a surfactant, and 1 to 150 parts by weight of a foaming agent are added to 100 parts by weight of a polyol to prepare a premixed polyol. Then, 1 to 99 parts by weight of a silane precursor and/or polysilsesquioxane is added to the premixed polyol. Subsequently, 101 to 150 parts by weight of an isocyanate is added to the mixture of the premixed polyol and the silane precursor and/or polysilsesquioxane, and then the resulting mixture is foamed. The silane precursor and polysilsesquioxane has a composition ratio of 1:9 to 9:1.

In example embodiments, a usable example of a silane precursor is represented by the following formula 1.

RₘSi(OR)₄₋ₘ [Formula 1]

wherein, R is an alkyl group having 1 to 5 carbon atoms or a phenyl group, and m is an integer of 0 to 3.

Examples of the silane precursor include methyl trimethoxy silane, methyl triethoxy silane, methyl tripropoxy silane, dimethyl dimethoxy silane, dimethyl diethoxy silane, diethoxy(3-glycidyloxypropyl)methyl silane, diethoxymethylphenyl silane, diethoxymethylvinyl silane, diphenyldiethoxy silane, dimethyldichloro silane, dimethylethoxyvinyl silane, ethyltrimethoxy silane, ethyltriethoxy silane, methyltrichloro silane, ethyltrichloro silane, tetraethyl orthosilicate, or the like, but it is not limited thereto.

In the method for preparing a polyurethane foam of example embodiments, it is preferable that an amount of the silane precursor is 3 to 50 parts by weight based on 100 parts by weight of the premixed polyol.

In example embodiments, a usable example of the polysilsesquioxane is represented by the following formula 2.

[R—SiO_{1.5}]ₙ [Formula 2]

wherein, R is at least one selected from the group consisting of alkyl having 1 to 3 carbon atoms, alkenyl having 1 to 3 carbon atoms, cycloalkyl having 3 to 10 carbon atoms, aryl having 6 to 15 carbon atoms, alkaryl having 1 to 3 carbon atoms, hydrogen, or hydroxyl, and n is an integer of 3 to 1000.

In the method for preparing a polyurethane foam of example embodiments, it is preferable that an amount of the polysilsesquioxane is 3 to 50 parts by weight based on 100 parts by weight of the premixed polyol. Moreover, it is preferable that the polysilsesquioxane has a weight-average molecular weight of 500 to 100,000 and includes 5 to 40% of a silanol group.

According to example embodiments, the silane precursor and/or polysilsesquioxane is dispersed into the polyurethane foam by being included in the isocyanate reaction to improve insulation performances and mechanical properties of the polyurethane foam.

In example embodiments, the premixed polyol includes a polyol, an amine catalyst, a surfactant, a foaming agent, and the like. The reaction content of each component is in the range widely known in this field of art.

The polyol used in example embodiments is an aliphatic compound having two or more hydroxyl groups (—OH) in the molecule. Examples of the polyol that can be used in example embodiments include polypropylene glycol polyols, amine terminated polyether polyols, polytrimethylene ether glycol polyol, polytrimethylene ether ester glycol polyol, polytrimethylene-co-ethylene ether glycol polyol, polytetramethylene ether glycol polyol, polyester polyols such as adipic acid, phthalic anhydride or terephthalic acid, or an arbitrary mixture thereof, but it is not particularly limited thereto.

As the foaming agent used in example embodiments, water is preferably used. Also, a foaming agent other than water can be used together with water. Examples of the other foaming agents include n-pentane, isopentane, cyclopentane, methyl chloride, 1,1,1,2-tetrafluoroethane, 1,1,1,3,3,-pentafluoropropane, 1,1,1,3,3,-pentafluorobutane, 1,1-dichloro-1-fluoroethane, 1-chloro-1,1-difluoroethane, chlorodifluoromethane, or the like.

In example embodiments, it is important to select and control a use amount of an appropriate catalyst for improving a foaming characteristic, a reaction time and an air permeability of the foam, and minimizing a density gradient. Examples of the catalyst that can be used in example embodiments include amine catalysts such as triethylamine, diethanol, amine, N,N,N,N′-tetramethylhexane diamine, N,N,N,N′-tetramethylethylene diamine, triethylene diamine, N-methylmorpholine, dimethylamino ethanol, bis(2-dimethylaminoethyl)ether, or 1,8-diazabicyclo(5,4,0)-undecene-7, and organometallic catalysts such as dibutyl laurate, dibutyl tin diacetate, stannous octoate, dibutyl mercaptide, dibutyl tin thiocarboxylate, dibutyl tin malate, dioctyl tin mercaptide, dioctyl tin thiocarboxylate, phenyl mercury, silver propionate, or tin octenaoate. Among these catalysts, an amine catalyst is inevitable, and if necessary, an organometallic catalyst may be added. It is also possible that a plurality of catalysts are used in a combination. Among these, a tertiary amine is particularly preferable. A reactivity of an amine catalyst is influenced by its basicity and steric hinderance.

The surfactant that can be used in example embodiments include nonionic polyether surfactants in addition to silicone surfactants. The silicone surfactants include commercially available polysiloxane/polyether copolymers, for example, Tegostab (B-8462 and B-8404 surfactants, manufactured by Goldschmidt Chemical Corp.), Niax (L-6900 and L-6910 surfactants, manufactured by GE Silicones), or DC-198 and DC-5043 surfactants (manufactured by Dow Corning Corp.). The nonionic polyether surfactant include ethylene oxide/propylene oxide and ethylene oxide/butylene oxide block copolymer. The surfactant gives stability to the foam by reducing a surface tension to improve miscibility, homogenizing the size of bubbles, and controlling the cell structure of the foam.

In the method for preparing a polyurethane foam, the polyurethane foam may further include a foam stabilizer, a cell control agent, a filler, a pigment, a dye, a flame retardant, a hydrolysis inhibitor, an antistatic agent, a colorant, an antibiotic, an antifungal agent, or a bacteriostatic agent within a range not to impair the compositional properties.

In example embodiments, the isocyanate in a base material that terms polyurethane by reacting with the polyol. Specific examples of the isocyanate include methylene diphenyl diisocyanate (MDI), polymeric methylene diphenyl diisocyanate, toluene diisocyanate (TDI), hexamethylene diisocyanate, trimethyl hexamethylene diisocyanate, phenylene diisocyanate, dimethyl diphenyl diisocyanate, tetra methylene diisocyanate, iso holon diisocyanate, diisocyanate, triphenyl methane triisocyanate, or an arbitrary mixture thereof, but it is not particularly limited thereto.

It is preferable that an amount of the isocyanate is 101 to 150 parts by weight based on 100 parts by weight of polyol.

According to the preparation method of example embodiments, the silica precursor and/or polysilsesquioxane is dispersed into the polyurethane foam by including a polyol and isocyanate as in the following reactions 1 and 2. As a result, a silicate/polyurethane foam or a polysilsesquioxane/polyurethane foam having improved mechanical properties and insulation characteristic can be prepared.

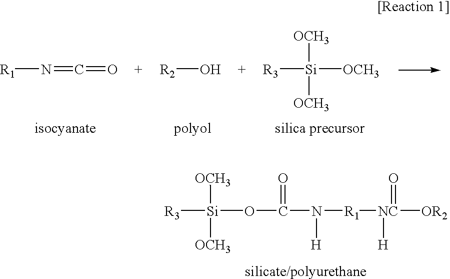

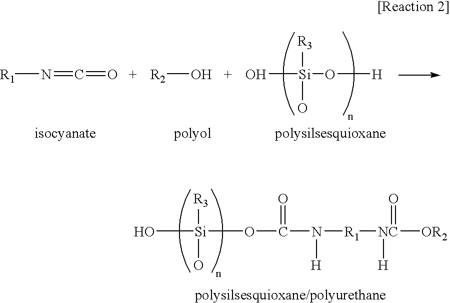

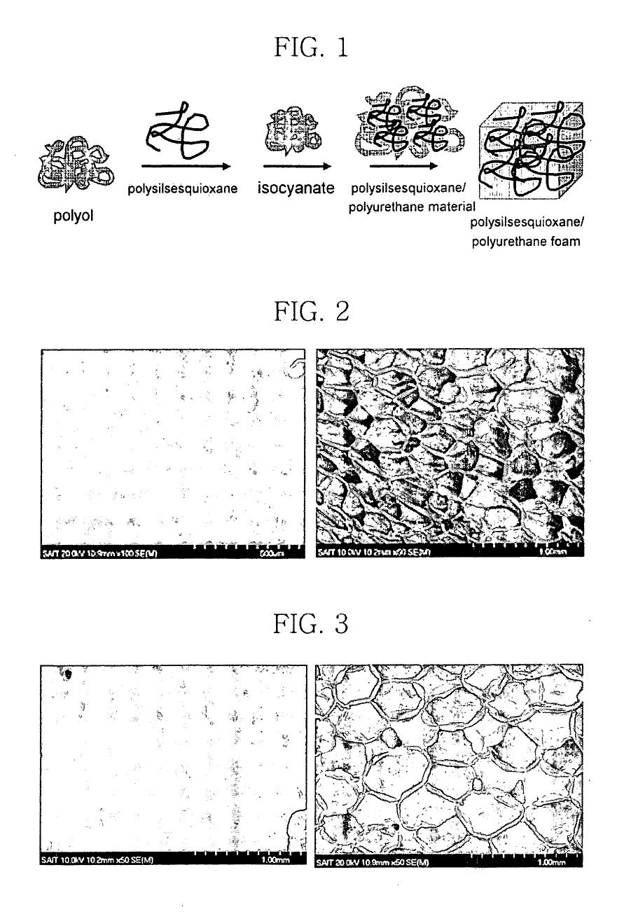

FIG. 1 is a schematic view illustrating a process for forming a polysilsesquioxane/polyurethane foam according to the above reaction. Referring to FIG. 1, the polysilsesquioxane is included in the reaction of a polyol and a methylene diisocyanate (MDI) to produce a deformed polyurethane in a form of polysilsesquioxane/polyurethane. This deformed polyurethane is foamed to obtain a polysilsesquioxane/polyurethane foam.

In the preparation method, it is preferable that the silane precursor or polysilsesquioxane is mixed to the premixed polyol with a mixing rate of 1000 to 10000 rpm, and a mixing time of 1 to 40 seconds.

According to another example embodiment, in the preparation method, the polysilsesquioxane may be added to the polyol by dissolving in at least a solvent selected from the group consisting of ethyl alcohol, isopropyl alcohol, benzene, toluene, xylene, methyl isobutyl ketone, acetone, tetrahydrofuran (THF), isopropyl ether, and silicon.

Example embodiments are also directed to a polyurethane foam prepared according to the above preparation method. The polyurethane foam prepared according to example embodiments are preferably used as insulation materials. Particularly, these materials are used for sound insulation materials or insulation of refrigerators.

Hereinafter, example embodiments will be explained in more detail with reference to the following examples. However, these examples are given for the purpose of illustration and are not to be construed as limiting the scope of example embodiments.

### EXAMPLES

### Example 1

### Preparation of Polyurethane Foam

Based on 100 parts by weight of a polyether polyol having a molecular weight of about 4000 (manufactured by Basf Corp.), a 5 parts by weight of an amine catalyst (Poly Cat (PC) Series; manufactured by Air Product and Chemicals, Inc.), 10 parts by weight of a silicone surfactant (Surfactant B Series; manufactured by Goldsmith, Inc.) and 40 parts by weight of a cyclopentane foaming agent were added to prepare a premixed polyol. Tetramethyl orthosilicate was added to the premixed polyol in an amount of 5 parts by weight based on 100 parts by weight of the premixed polyol. Then, the mixture was stirred at 1000 rpm for 10 seconds. Subsequently, an isocyanate was added to the mixture in an amount of 150 parts by weight based on 100 parts by weight of the premixed polyol, and the resulting mixture was stirred at 2000 rpm for 10 seconds. Thereafter, the mixture was poured into a mold to prepare a polyurethane foam.

An FESEM image of the silicate/polyurethane foam prepared in Example 1 is illustrated in FIG. 2.

The left image of FIG. 2 is a surface view of the silicate/polyurethane foam prepared in Example 1, which indicates that the surface of the foam is homogenous. The right image of FIG. 2 is a sectional view of the silicate/polyurethane foam prepared in Example 1, which indicates that a cell diameter is about 297 μm.

FIG. 3 is a surface FESEM image (left) and a sectional FESEM image (right) of a polyurethane foam according to an embodiment of a conventional art. The left image of FIG. 3 is a surface view of a polyurethane foam, and the right image of FIG. 3 is a sectional view of the polyurethane foam, which indicates that a cell diameter is about 442 μm. Therefore, it is known that the silicate/polyurethane foam compared with the polyurethane foam of FIG. 3 has reducing effect of thermal conductivity due to a homogenous surface and a smaller cell size.

### Example 2

In the same manner as in Example 1, a polyurethane foam was prepared, except that 10 parts by weight of tetramethyl orthosilicate was added.

### Example 3

In the same manner as in Example 1, a polyurethane foam was prepared, except that 15 parts by weight of tetramethyl orthosilicate was added.

### Example 4

In the same manner as in Example 1, a polyurethane foam was prepared, except that 15 parts by weight of aminopropyl trimethoxysilane was added instead of 5 parts by weight of tetramethyl orthosilicate.

### Preparation Example 1

### Synthesis of Polysilsesquioxane Resin

6 g of methyltrimethoxysilane monomer was put into a 100-ml flask, and 11.5 g of tetrahydrofuran (THF) was prepared. In another container, a mixed solution of 7.2 g of water and 0.42 g of concentrated hydrochloric acid containing 35% of hydrochloride was prepared. Maintaining the reaction system at 60° C., the prepared silane monomer and the THF were mixed with nitrogen with a flow of nitrogen. While stirring the resulting solution, the concentrated hydrochloric acid diluted with water was added dropwise over 4 hours. After the completion of the reaction, the precipitates were filtered out under reduced pressure, and the solution was transferred to a separatory funnel. 60 ml of anhydrous diethylether was added to the solution, and then the resulting solution was washed with 50 ml of water four times to remove the residual acid. A volatile substance in the obtained clear solution was removed using a vacuum pump to obtain polymethylsilsesquioxane, having a weight-average molecular weight of 4000, in a form of a powder. The content of silanol in the obtained polysilsesquioxane was 25%.

### Example 5

The polysilsesquioxane resin containing 25% of silanol obtained in Preparation Example 1 was dissolved in methyl isobutylketone in prepare 15 parts by weight of a resin solution. In the same manner as in Example 1, a polyurethane foam was prepared, except that 5 parts by weight of the polysilsesquioxane resin solution was added instead of 5 parts by weight of tetramethyl orthosilicate.

### Example 6

In the same manner as in Example 5, a polyurethane foam was prepared, except that 10 parts by weight of the polysilsesquioxane resin solution containing 25% of silanol was added.

### Example 7

In the same manner as in Example 6, a polyurethane foam was prepared, except that 5 parts by weight of tetramethyl orthosilicate and 5 parts by weight of the polysilsesquioxane resin solution containing 25% of silanol were added simultaneously.

### Comparative Example 1

In the same manner as in Example 1, a polyurethane foam was prepared, except that tetramethyl orthosilicate or the polysilsesquioxane resin solution was not added.

A thermal conductivity and density of the polyurethane foams obtained in Examples 1 to 7 and Comparative Example 1 were measured, and the results are presented in the following Table 1.

TABLE 1

| | | | | | | | | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 1 |
| Thermal | 0.0205 | 0.0206 | 0.0211 | 0.0137 | 0.0214 | 0.0212 | 0.0198 | 0.0226 |
| conductivity | | | | | | | | |
| (kcal/mh ° C.) | | | | | | | | |
| Density | 34.0 | 33.9 | 33.8 | 34.0 | 34.9 | 34.6 | 34.6 | 34.6 |
| (kg/m³) | | | | | | | | |

The thermal conductivity was measured using a heat flow technique by disposing a polyurethane foam sample having a size of 20 cm×20 cm×2 cm in between two heat plates of a Netzcsch HFM 436 series Thermal Conductivity Meter. At this time, the amount of heat being passed through the sample is measured by a compensated calorie sensor. The measurement is repeated 5 or 6 times to measure the thermal conductivity, and these values were averaged. The density was calculated by measuring the volume and weight of the prepared foam.

As can be seen from Table 1, it was known that when a silane precursor and/or polysilsesquioxane was added to a polyurethane foam, the thermal conductivity reduced while maintaining the density in a similar manner compared with a polyurethane foam which did not have added a silane precursor and/or a polysilsesquioxane.

Although example embodiments have been disclosed for illustrative purposes, those skilled in the art will appreciate that various modifications and variations are possible, without departing from the scope and spirit of the appended claims. Accordingly, such modifications and variations are intended to come within the scope of the claims.

What is claimed is:

1. A composition for polyurethane foam comprising a premixed polyol and isocyanate, and further comprising at least one among a silane precursor and polysilsesquioxane.

2. The composition according to claim 1, wherein the premixed polyol comprises a polyol, a catalyst, a surfactant, and a foaming agent.

3. The composition according to claim 1, wherein the composition comprises 100 parts by weight of polyol, 1 to 99 parts by weight of a silane precursor or polysilsesquioxane, 101 to 150 parts by weight of isocyanate, 0.1 to 50 parts by weight of a catalyst, 0.1 to 50 parts by weight of a surfactant, and 1 to 150 parts by weight of a foaming agent.

4. The composition according to claim 1, wherein the composition comprises 100 parts by weight of polyol, 1 to 99 parts by weight of a silane precursor or polysilsesquioxane, 101 to 150 parts by weight of isocyanate, 0.1 to 50 parts by weight of a catalyst, 0.1 to 50 parts by weight of a surfactant, and 1 to 150 parts by weight of a foaming agent.

5. The composition according to claim 4, wherein the silane precursor and polysilsesquioxane have a composition ratio of 1:9 to 9:1.

6. The composition according to claim 1, wherein the silane precursor is represented by the formula 1,
RₘSi(OR)₄₋ₘ [Formula 1]
wherein, R is an alkyl group having 1 to 5 carbon atoms or a phenyl group, and m is an integer of 0 to 3.

7. The composition according to claim 6, wherein the silane precursor is at least one selected from the group consisting of methyl trimethoxy silane, methyl triethoxy silane, methyl tripropoxy silane, dimethyl dimethoxy silane, dimethyl diethoxy silane, diethoxy(3-glycidyloxypropyl)methyl silane, diethoxymethylphenyl silane, diethoxymethylvinyl silane, diphenyldiethoxy silane, dimethyldichloro silane, dimethylethoxyvinyl silane, ethyltrimethoxy silane, ethyltriethoxy silane, methyltrichloro silane, ethyltrichloro silane, and tetraethyl orthosilicate.

8. The composition according to claim 1, wherein the polysilsesquioxane is represented as formula 2,
[R—SiO_{1.5}]ₙ [Formula 2]
wherein, R is at least one selected from the group consisting of alkyl having 1 to 3 carbon atoms, alkenyl having 1 to 3 carbon atoms, cycloalkyl having 3 to 10 carbon atoms, aryl having 6 to 15 carbon atoms, alkaryl having 1 to 3 carbon atoms, hydrogen, or hydroxyl, and n is an integer of 3 to 1000.

9. The composition according to claim 8, wherein the polysilsesquioxane has a weight-average molecular weight of 500 to 100,000.

10. The composition according to claim 8, wherein the polysilsesquioxane contains 5 to 40% of a silanol group.

11. A method for preparing a polyurethane foam comprising:
adding a catalyst, a surfactant, and a foaming agent to a polyol to prepare a premixed polyol;
mixing at least one among a silane precursor and polysilsesquioxane to the premixed polyol; and
mixing isocyanate to the mixture to carry out foaming.

12. The method according to claim 11, wherein the polyurethane foam comprises 100 parts by weight of polyol, 1 to 99 parts by weight of a silane precursor or polysilsesquioxane, 101 to 150 parts by weight of isocyanate, 0.1 to 50 parts by weight of a catalyst, 0.1 to 50 parts by weight of a surfactant, and 1 to 150 parts by weight of a foaming agent.

13. The method according to claim 11, wherein the polyurethane foam comprises 100 parts by weight of polyol, 1 to 99 parts by weight of a silane precursor or polysilsesquioxane, 101 to 150 parts by weight of isocyanate, 0.1 to 50 parts by weight of a catalyst, 0.1 to 50 parts by weight of a surfactant, and 1 to 150 parts by weight of a foaming agent.

14. The method according to claim 13, wherein the silane precursor and polysilsesquioxane have a composition ratio of 1:9 to 9:1.

15. The method according to claim 11, wherein the silane precursor is represented by the formula 1,
RₘSi(OR)₄₋ₘ [Formula 1]
wherein, R is an alkyl group having 1 to 5 carbon atoms or a phenyl group, and m is an integer of 0 to 3.

16. The method according to claim 15, wherein the silane precursor is at least one selected from the group consisting of methyl trimethoxy silane, methyl triethoxy silane, methyl tripropoxy silane, dimethyl dimethoxy silane, dimethyl diethoxy silane, diethoxy(3-glycidyloxypropyl)methyl silane, diethoxymethylphenyl silane, diethoxymethylvinyl silane, diphenyldiethoxy silane, dimethyldichloro silane, dimethylethoxyvinyl silane, ethyltrimethoxy silane, ethyltriethoxy silane, methyltrichloro silane, ethyltrichloro silane, and tetraethyl orthosilicate.

17. The method according to claim 11, wherein the polysilsesquioxane is represented as formula 2,
[R—SiO_{1.5}]ₙ [Formula 2]
wherein, R is at least one selected from the group consisting of alkyl having 1 to 3 carbon atoms, alkenyl having 1 to 3 carbon atoms, cycloalkyl having 3 to 10 carbon atoms, aryl having 6 to 15 carbon atoms, alkaryl having 1 to 3 carbon atoms, hydrogen, or hydroxyl, and n is an integer of 3 to 1000.

18. The method according to claim 17, wherein the polysilsesquioxane has a weight-average molecular weight of 500 to 100,000.

19. The method according to claim 17, wherein the polysilsesquioxane contains 5 to 40% of a silanol group.

20. The method according to claim 11, wherein the polysilsesquioxane is added to the polyol by dissolving in at least a solvent selected from the group consisting of ethyl alcohol, isopropyl alcohol, benzene, toluene, xylene, methyl isobutyl ketone, acetone, tetrahydrofuran (THF), isopropyl ether, and silicon.

21. The method according to claim 11, wherein at least one among silane precursor and polysilsesquioxane is mixed to the premixed polyol with a mixing rate of 1000 to 10000 rpm.

22. The method according to claim 11, wherein at least one among silane precursor and polysilsesquioxane is mixed to the premixed polyol with a mixing time of 1 to 40 seconds.

23. A polyurethane foam prepared using the composition for a polyurethane foam according to claim 1.
